(19) United States
(12) Patent Application Publication
(10) Pub. No.: US 2024/0234885 A1
(43) Pub. Date: Jul. 11, 2024

(54) BATTERY CELLS WITH WELD-FREE EXTERNAL LEAD TABS

(71) Applicant: GM GLOBAL TECHNOLOGY OPERATIONS LLC, Detroit, MI (US)

(72) Inventors: Jingyuan LIU, Shanghai (CN); John Christian KALIL, Washington, MI (US); Sherman H. ZENG, Troy, MI (US); Hadley GRIFFIN, Grosse Pointe Farms, MI (US); Haijing Liu, Shanghai (CN)

(21) Appl. No.: 18/358,470

(22) Filed: Jul. 25, 2023

(30) Foreign Application Priority Data
Jan. 6, 2023 (CN) 202310023536.4

(51) Int. Cl. H01M 50/172; H01M 10/04; H01M 50/533; H01M 50/538

(52) U.S. Cl. CPC H01M 50/172; H01M 10/0459; H01M 50/533; H01M 50/538

(57) ABSTRACT

A battery cell comprises an electrode stack including A anode electrodes with A anode current collectors. A external tabs extend from the first side of the A anode electrodes. C cathode electrodes include C cathode current collectors and C external tabs. A separator comprises a continuous sheet interleaved between the anode electrodes and the C cathode electrodes. The A external tabs of the A anode electrodes are folded along the separator on the first side of the A anode electrodes. The C external tabs of the C cathode electrodes are folded along the separator on the second side the C cathode electrodes. The electrode stack is arranged in a housing. First and second tab positioning members including first and second external lead tabs are connected to the A external tabs and the C external tabs, respectively.

### CROSS-REFERENCE TO RELATED APPLICATIONS

This application claims the benefit of Chinese Patent Application No. 202310023536.4, filed on Jan. 6, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells with weld-free external lead tabs.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs.

### SUMMARY

A battery cell comprises an electrode stack including A anode electrodes with A anode current collectors having a first side, a second side, a first end, and a second end. The first side and the second side are longer than the first end and the second end, respectively. A external tabs extend from the first side of the A anode electrodes. C cathode electrodes with C cathode current collectors having a first side, a second side, a first end, and a second end. The first side and the second side are longer than the first end and the second end, and wherein C external tabs extend from the second side of the C cathode electrodes, where A and C are integers greater than zero. A separator comprises a continuous sheet interleaved between the anode electrodes and the C cathode electrodes. The A external tabs of the A anode electrodes are folded along the separator on the first side of the A anode electrodes. The C external tabs of the C cathode electrodes are folded along the separator on the second side the C cathode electrodes. A housing including a first side, a second side, a first end, a second end, and an internal cavity, wherein the electrode stack is arranged in the internal cavity with the A external tabs and the C external tabs adjacent to the first side and the second side, respectively. First and second tab positioning members including first and second external lead tabs connected to the A external tabs and the C external tabs, respectively.

In other features, the electrode stack is inserted into the internal cavity through one of the first side and the second side. Each of the first end and the second end of the housing includes first and second slots configured to engage opposite ends of the first tab positioning member and the second tab positioning member. The first tab positioning member includes a planar conducting portion extending along the first side of the housing and in contact with the A external tabs and an external lead tab connected to the planar conducting portion.

In other features, the first tab positioning member further includes a planar insulating portion arranged adjacent to the planar conducting portion and a second insulating portion extending transverse from the planar insulating portion. The external lead tab extends through the second insulating portion.

In other features, the second tab positioning member includes a planar conducting portion extending along the second side of the housing and in contact with the C external tabs; and an external lead tab connected to the planar conducting portion.

In other features, the second tab positioning member further includes a planar insulating portion arranged adjacent to the planar conducting portion; and a second insulating portion extending transverse from the planar insulating portion. The external lead tab extends through the second insulating portion. The first tab positioning member includes an “L”-shaped planar conducting portion extending along the first side and the first end of the housing and in contact with the A external tabs; and an external lead tab connected to the “L”-shaped planar conducting portion adjacent to the first end.

In other features, the first tab positioning member further includes an “L”-shaped planar insulating portion arranged adjacent to the “L”-shaped planar conducting portion; and a second insulating portion extending transverse to the “L”-shaped planar insulating portion adjacent to the first end. The external lead tab extends through the second insulating portion.

In other features, the second tab positioning member includes an “L”-shaped planar conducting portion extending along the second side of the housing and the second end of the housing and in contact with the C external tabs; and an external lead tab connected to the “L”-shaped planar conducting portion adjacent to the second end.

In other features, the second tab positioning member further includes an “L”-shaped planar insulating portion arranged adjacent to the “L”-shaped planar conducting portion, and a second insulating portion extending transverse to the “L”-shaped planar insulating portion adjacent to the second end. The external lead tab extends through the second insulating portion.

In other features, the first tab positioning member includes a planar conducting portion arranged along the first end of the housing; an external lead tab connected to the planar conducting portion; and a second planar conducting portion arranged along the first side of the housing, in contact with the A external tabs of the A anode electrodes, and including an end abutting the planar conducting portion.

In other features, the second tab positioning member includes a planar conducting portion arranged along the second end of the housing; an external lead tab connected to the planar conducting portion; and a second planar conducting portion arranged along the second side of the housing, in contact with the C external tabs of the C cathode electrodes and including an end abutting the planar conducting portion.

A battery cell comprises an electrode stack including A anode electrodes with A anode current collectors having a first side, a second side, a first end, and a second end. The first side and the second side are longer than the first end and the second end, respectively, and wherein A external tabs extend from the first side of the A anode electrodes. C cathode electrodes with C cathode current collectors have a first side, a second side, a first end, and a second end. The first side and the second side are longer than the first end and the second end, and wherein C external tabs extend from the second side of the C cathode electrodes, where A and C are integers greater than zero. A separator comprises a continuous sheet interleaved between the anode electrodes and the C cathode electrodes. The A external tabs of the A anode electrodes are folded along the separator on the first side of the A anode electrodes. The C external tabs of the C cathode electrodes are folded along the separator on the second side of the C cathode electrodes. A housing includes a first side, a second side, a first end, a second end, and an internal cavity, wherein the electrode stack is arranged in the internal cavity with the A external tabs and the C external tabs adjacent to the first side and the second side, respectively. First and second tab positioning members including first and second external lead tabs connected to the A external tabs and the C external tabs, respectively. The first tab positioning member includes a planar conducting portion extending along the first side of the housing and in contact with the A external tabs, and an external lead tab connected to the planar conducting portion adjacent to the first side of the housing.

In other features, each of the first end and the second end of the housing includes first and second slots configured to engage opposite ends of the first tab positioning member and the second tab positioning member. The first tab positioning member further includes a planar insulating portion arranged adjacent to the planar conducting portion; and a second insulating portion extending transverse from the planar insulating portion. The external lead tab extends through the second insulating portion.

In other features, the second tab positioning member includes a planar conducting portion extending along the second side of the housing and in contact with the C external tabs and an external lead tab connected to the planar conducting portion.

In other features, the second tab positioning member further includes a planar insulating portion arranged adjacent to the planar conducting portion, and a second insulating portion extending transverse from the planar insulating portion. The external lead tab extends through the second insulating portion.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell;

FIG. 2 is a cross-sectional plan view of an example of a battery cell;

FIG. 3A is a plan view of an example of an electrode including uncoated current collector part to connect to external tab;

FIG. 3B is a plan view of an example of an electrode stack including uncoated current collector part to connect to external tab along ends thereof;

FIG. 4A is a plan view of an example of an electrode including uncoated current collector part to connect to external tab according to the present disclosure;

FIG. 4B is a plan view of an example of an electrode stack including uncoated current collector part to connect to external tab along sides thereof according to the present disclosure;

FIG. 5 is a cross-sectional plan view of an example of a battery cell according to the present disclosure;

FIG. 6 is a cross-sectional plan view of an example of a battery cell with folded external tabs according to the present disclosure;

FIG. 7 is a perspective view of an example of tab positioning members and external tabs connected to an electrode stack of a battery cell according to the present disclosure;

FIGS. 8A and 8B are an exploded side view and a side view, respectively, of an example of a battery cell arranged in a housing according to the present disclosure;

FIGS. 9A and 9B are an exploded side view and a side view, respectively, of another example of a battery cell arranged in a housing according to the present disclosure;

FIGS. 10A and 10B are an exploded side view and a side view, respectively, of another example of a battery cell arranged in a housing according to the present disclosure; and

FIG. 11 is a partial view of an example of a housing for the battery cell including a slot.

In the drawings, reference numbers may be reused to identify similar and/or identical elements.

### DETAILED DESCRIPTION

While the battery cells are described herein in the context of EVs, the battery cells can be used in stationary applications and/or in other applications.

Battery cells include an electrode stack with anode electrodes, cathode electrodes, and separators. The anode electrodes including anode coatings arranged on anode current collectors. The cathode electrodes including cathode coatings arranged on cathode current collectors. External tabs extend from the anode current collectors and cathode current collectors. External lead tabs and the external tabs for the cathodes and anodes are welded together, respectively.

Welds between the external tabs of the anode and cathode current collectors and the external lead tabs are easily torn off, which leads to failure of battery cells. The battery cells fail when the external tabs of the current collectors on sides of the battery cell are stretched more than the external tabs of the current collectors in the middle of the battery cell. In other words, pulling force is greater on sides as compared to the middle. The external tabs also fail because the weld at the external lead tab conducts external force to connections inside of the battery cell, (including force on a bus bar and/or shaking of battery module/pack).

The weld-free battery cell according to the present disclosure eliminates the welds between the external lead tabs and the current collectors of the electrodes by changing the stacking procedure and by using external tabs extending along sides of the electrodes rather than ends of the electrodes. Eliminating welds at the external lead tabs and the current collector is expected to increase reliability of the battery cell and reduce battery cell failure.

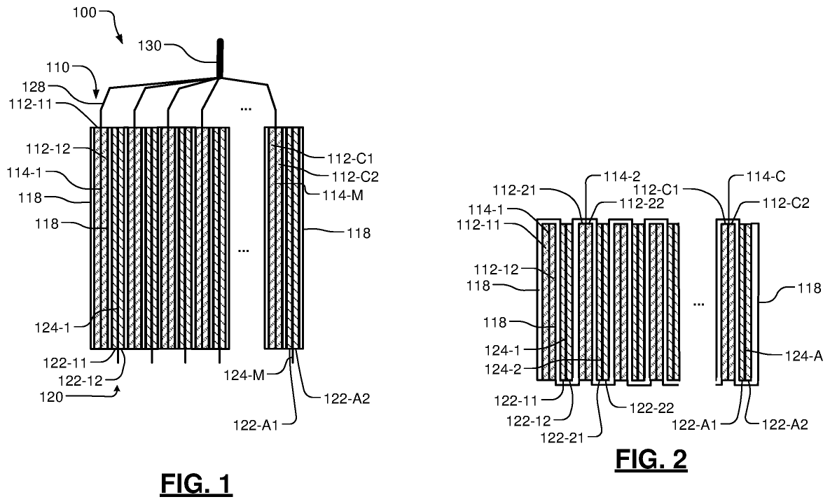

Referring now to FIGS. 1 and 2, a battery cell 100 includes a stack of cathode electrodes 110 and anode electrodes 120. In some examples, the cathode electrodes 110 and anode electrodes 120 are arranged in an alternating arrangement with separators 118 arranged therebetween. The cathode electrodes 110 include a cathode electrode coating 112-11, 112-12, . . . , 112-C1, and 112-C2 arranged on opposite sides of cathode current collectors 114-1, . . . , and 114-C, respectively. In some examples, the cathode electrode coating includes cathode active material, binder, solvent, and/or additives. In some examples, the cathode current collectors are made of aluminum foil.

The anode electrodes 120 include an anode electrode coating 122-11, 122-12, . . . , 122-C1, and 122-C2 arranged on opposite sides of anode collectors 124-1, . . . , and 124-C, respectively. In some examples, the anode electrode coating includes anode active material, binder, solvent, and/or additives. In some examples, the anode current collectors are made of copper foil. In FIG. 1, A, C and S are integers that are greater than one.

An external lead tab 130 is welded to external tabs 128 extending from the cathode current collectors (a similar approach is used for the anode current collectors on the opposite side). In FIG. 2, the separators 118 include a single continuous separator sheet interleaved between the cathode electrodes 110 and anode electrodes 120.

External force is conducted through the external lead tab 130 and the external tabs 128 to the current collectors inside the battery cell, which leads to torn or other failure especially for aged battery cells. The welds in this region have increased resistance due to reduced conduction, which increases heat generation in this location. Current collectors at outer edges of the battery cell experience higher force and tend to fail more quickly as compared to current collectors in the middle of the battery cell.

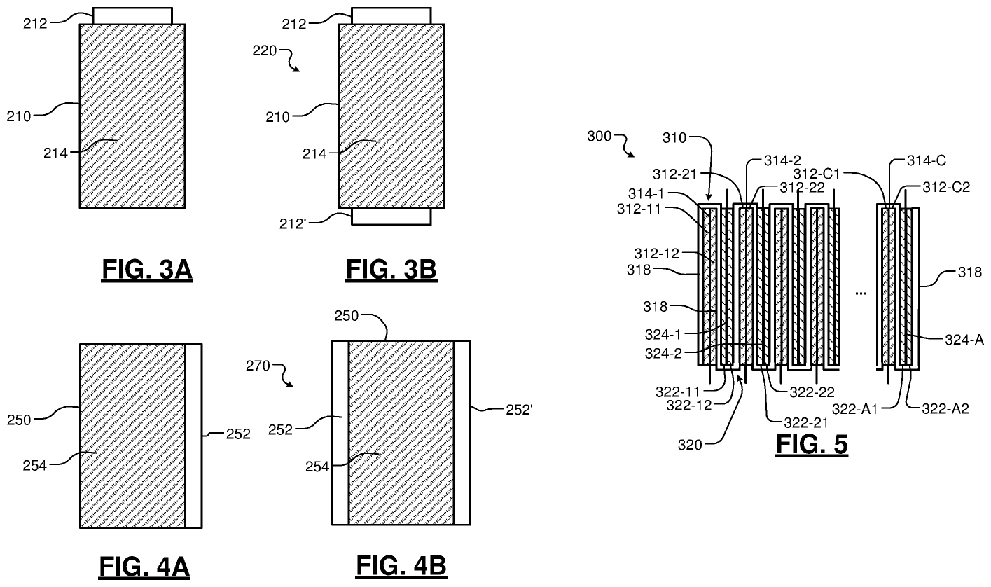

Referring now to FIGS. 3A and 3B, an electrode 210 (such as an anode or cathode electrode) typically includes an external tab 212 extending from the current collector on an end of the electrode 210. Electrode coatings 214 are arranged on one or both sides of the current collector. When the anode and cathode electrodes are arranged in a stack 220, the external tabs 212 and 212′ extend from opposite ends of the electrodes 210. In other words, the external tabs 212 on one side correspond to the anode or cathode electrode and the external tabs 212′ on the opposite side correspond to the cathode or anode electrode.

Referring now to FIGS. 4A and 4B, an electrode 250 (such as an anode or cathode electrode) includes an external tab 252 extending from the current collector on the side of the electrode 250. Electrode coatings 254 are arranged on one or both sides of the current collector. When the anode and cathode electrodes are arranged in a stack 270, the external tabs 252 and 252′ extend from opposite ends of the electrodes 250. In other words, the external tabs 252 on one side correspond to the anode or cathode electrode and the external tabs 252′ on the opposite side correspond to the cathode or anode electrode.

Referring now to FIG. 5, a battery cell 300 includes a stack of cathode electrodes 310 and anode electrodes 320. In some examples, the cathode electrodes 310 and anode electrodes 320 are arranged in an alternating arrangement with separators 318 arranged therebetween. In other examples such as a bipolar battery cell, a different arrangement of the cathode electrodes and anode electrodes may be used.

The cathode electrodes 310 include a cathode electrode coating 312-11, 312-12, . . . , 312-C1, and 312-C2 arranged on one or both sides of cathode current collectors 314-1, . . . , and 314-C, respectively. In some examples, the cathode electrode coating includes cathode active material, binder, solvent, and/or additives. In some examples, the cathode current collectors 314 are made of aluminum foil.

The anode electrodes 320 include an anode electrode coating 322-11, 322-12, . . . , 322-C1, and 322-C2 arranged on one or both sides of anode collectors 324-1, . . . , and 324-C, respectively. In some examples, the anode electrode coating includes anode active material, binder, solvent, and/or additives. In some examples, the anode current collectors 324 are made of copper foil. As can be seen, the external tabs extend from sides of the electrodes as shown in FIGS. 4A and 4B.

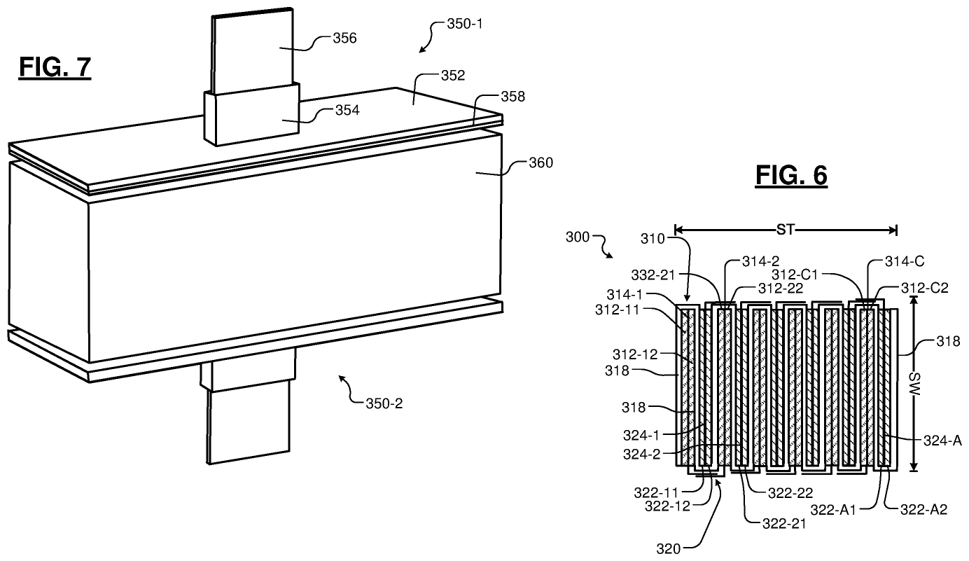

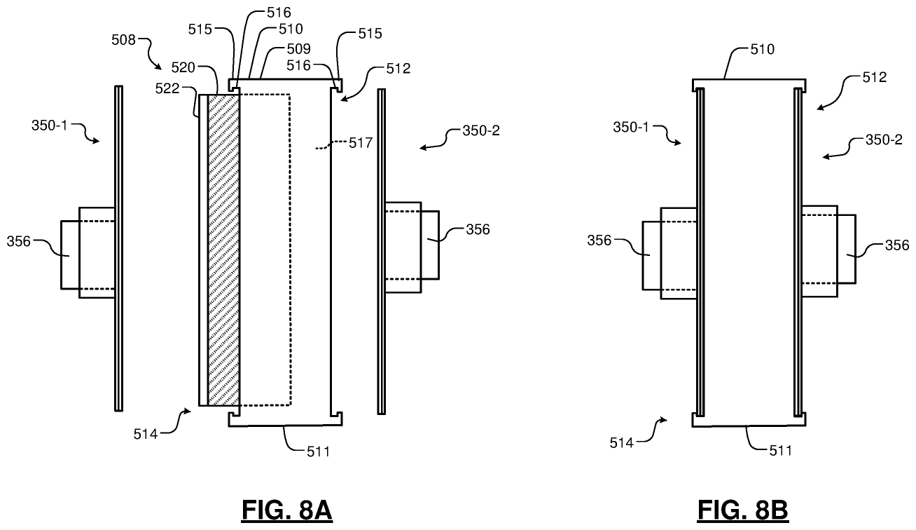

Referring now to FIGS. 6 and 7, connections to the external tabs of the electrodes are shown. In FIG. 6, the external tabs of the electrodes are folded and arranged along sides of the separators. In FIG. 6, a stacking thickness (ST) and stacking width (SW) of the battery cell is shown. A stacking length (SL) of the battery cell is orthogonal to the ST and SW of the battery cell (e.g., perpendicular to the page including FIG. 6). The separators help to prevent contact between the external tabs and the adjacent current collectors.

In FIG. 7, tab positioning members 350-1 and 350-2 are connected to the folded external tabs of the electrodes. The tab positioning member 350-1 includes a planar conducting portion 358 (abutting the external tabs of the anode or cathode electrodes). A planar insulating portion 352 including a transverse portion 354 extends upwardly therefrom. An external lead tab 356 extends through the transverse portion 354 and connects to the planar conducting portion 358. The tab positioning members 350-1 and 350-2 provide connections to the external tabs of the electrodes. In some examples, a length and width of the tab positioning members 350-1 and 350-2 is less than or equal to a stacking length (SL) and a stacking thickness (ST) of the battery cell.

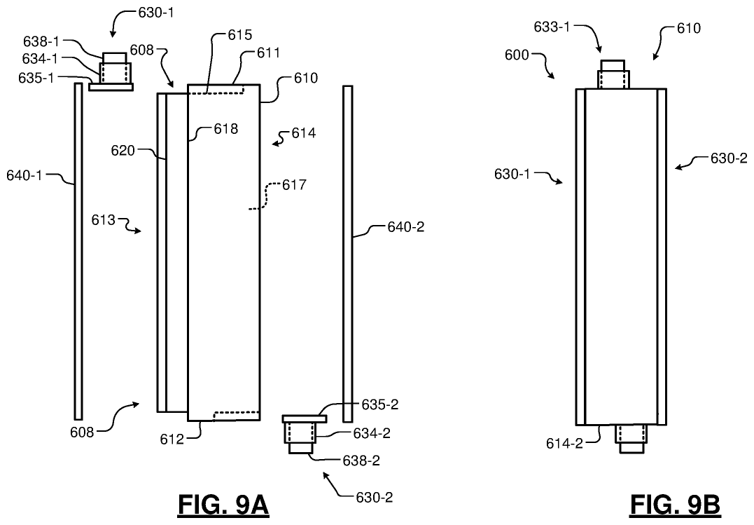

Referring now to FIGS. 8A and 8B, a battery cell 508 is arranged in a housing 509. In FIG. 8A, the housing 509 includes a first end 510 and a second end 511 defining projections 515 extending from the housing 509 and slots 516. The housing 509 defines an inner cavity 517 with side openings 512 and 514. An electrode stack 520 including anode and cathode electrodes and separators is arranged in the inner cavity 517. The tab positioning members 350-1 and 350-2 slide into the slots 516 as shown in FIG. 8B (transverse to a plane parallel to planes including the electrodes in the stack) to provide connections to the external tabs of the electrodes.

Referring now to FIGS. 9A and 9B, a battery cell 608 is arranged in a housing 610. In FIG. 9A, the housing 610 includes a first end 611 and a second end 612 defining slots 615. The housing 610 defines an inner cavity 617 with side openings 613 and 614. An electrode stack 620 including electrodes and separators is arranged in the inner cavity 617. Tab positioning members 630-1 and 630-2 slide into the slots 615 arranged along the ends of the housing as shown in FIG. 9B.

The tab positioning members 630-1 and 630-2 include conducting portions 635-1 and 635-2 that are arranged in a plane parallel to the ends of the housing, insulating portions 634-1 and 634-2 extending transverse to the conducting portions 635-1 and 635-2, and external tabs 638-1 and 638-2 connected to the conducting portions 635-1 and 635-2 (through the insulating portions 634-1 and 634-2), respectively. Planar conducting portions 640-1 and 640-2 abut and provide a connection between the external tabs of the electrodes and the conducting portions 635-1 and 635-2 of the tab positioning members 630-1 and 630-2.

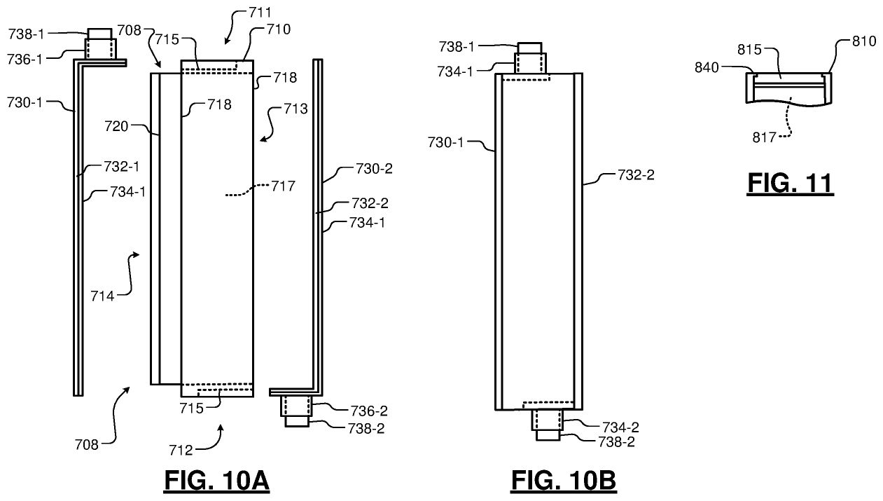

Referring now to FIGS. 10A and 10B, a battery cell 708 is arranged in a housing 710. In FIG. 9A, the housing 710 includes a first end 711 and a second end 712 defining slots 715. The housing 710 defines an inner cavity 717 with side openings 713 and 714. An electrode stack 720 including electrodes and separators is arranged in the inner cavity 717.

Tab positioning members 730-1 and 730-2 slide into the slots 715 as shown in FIG. 8B. The tab positioning members 730-1 and 730-2 include conducting portions 732-1 and 732-2 having an “L”-shape and insulating portions 734-1 and 734-2 having an “L”-shape. Transverse insulating portions 736-1 and 736-2 extend from the insulating portions 734-1 and 734-2 along ends of the housing. External lead tabs 738-1 and 738-2 extend through the transverse insulating portions 736-1 and 736-2 and are connected to the conducting portions 732-1 and 732-2, respectively. The tab positioning members 730-1 and 730-2 provide connections between the external tabs of the electrodes and the external lead tabs 738-1 and 738-2.

Referring now to FIG. 11, a housing 810 for the battery cell includes a slot 815 with a projection 840. The projection 840 helps to maintain the tab positioning members in position when inserted into the slot 815 at ends of the housing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
an electrode stack including:
A anode electrodes with A anode current collectors having a first side, a second side, a first end, and a second end,
wherein the first side and the second side are longer than the first end and the second end, respectively, and wherein A external tabs extend from the first side of the A anode electrodes;
C cathode electrodes with C cathode current collectors having a first side, a second side, a first end, and a second end,
wherein the first side and the second side are longer than the first end and the second end, and wherein C external tabs extend from the second side of the C cathode electrodes, where A and C are integers greater than zero; and
a separator comprising a continuous sheet interleaved between the anode electrodes and the C cathode electrodes,
wherein the A external tabs of the A anode electrodes are folded along the separator on the first side of the A anode electrodes;
wherein the C external tabs of the C cathode electrodes are folded along the separator on the second side the C cathode electrodes;
a housing including a first side, a second side, a first end, a second end, and an internal cavity, wherein the electrode stack is arranged in the internal cavity with the A external tabs and the C external tabs adjacent to the first side and the second side, respectively; and
first and second tab positioning members including first and second external lead tabs connected to the A external tabs and the C external tabs, respectively.

2. The battery cell of claim 1, wherein the electrode stack is inserted into the internal cavity through one of the first side and the second side.

3. The battery cell of claim 2, wherein each of the first end and the second end of the housing includes first and second slots configured to engage opposite ends of the first tab positioning member and the second tab positioning member.

4. The battery cell of claim 2, wherein the first tab positioning member includes:
a planar conducting portion extending along the first side of the housing and in contact with the A external tabs; and
an external lead tab connected to the planar conducting portion.

5. The battery cell of claim 4, wherein the first tab positioning member further includes:
a planar insulating portion arranged adjacent to the planar conducting portion; and
a second insulating portion extending transverse from the planar insulating portion,
wherein the external lead tab extends through the second insulating portion.

6. The battery cell of claim 2, wherein the second tab positioning member includes:
a planar conducting portion extending along the second side of the housing and in contact with the C external tabs; and
an external lead tab connected to the planar conducting portion.

7. The battery cell of claim 6, wherein the second tab positioning member further includes:
a planar insulating portion arranged adjacent to the planar conducting portion; and
a second insulating portion extending transverse from the planar insulating portion,
wherein the external lead tab extends through the second insulating portion.

8. The battery cell of claim 2, wherein the first tab positioning member includes:
an “L”-shaped planar conducting portion extending along the first side and the first end of the housing and in contact with the A external tabs; and
an external lead tab connected to the “L”-shaped planar conducting portion adjacent to the first end.

9. The battery cell of claim 8, wherein the first tab positioning member further includes:
an “L”-shaped planar insulating portion arranged adjacent to the “L”-shaped planar conducting portion; and
a second insulating portion extending transverse to the “L”-shaped planar insulating portion adjacent to the first end,
wherein the external lead tab extends through the second insulating portion.

10. The battery cell of claim 2, wherein the second tab positioning member includes:
an “L”-shaped planar conducting portion extending along the second side of the housing and the second end of the housing and in contact with the C external tabs; and
an external lead tab connected to the “L”-shaped planar conducting portion adjacent to the second end.

11. The battery cell of claim 10, wherein the second tab positioning member further includes:
an “L”-shaped planar insulating portion arranged adjacent to the “L”-shaped planar conducting portion; and
a second insulating portion extending transverse to the “L”-shaped planar insulating portion adjacent to the second end,
wherein the external lead tab extends through the second insulating portion.

12. The battery cell of claim 2, wherein the first tab positioning member includes:
a planar conducting portion arranged along the first end of the housing;
an external lead tab connected to the planar conducting portion; and
a second planar conducting portion arranged along the first side of the housing, in contact with the A external tabs of the A anode electrodes, and including an end abutting the planar conducting portion.

13. The battery cell of claim 2, wherein the second tab positioning member includes:
a planar conducting portion arranged along the second end of the housing;
an external lead tab connected to the planar conducting portion; and
a second planar conducting portion arranged along the second side of the housing, in contact with the C external tabs of the C cathode electrodes and including an end abutting the planar conducting portion.

14. A battery cell comprising:
an electrode stack including:
A anode electrodes with A anode current collectors having a first side, a second side, a first end, and a second end,
wherein the first side and the second side are longer than the first end and the second end, respectively, and wherein A external tabs extend from the first side of the A anode electrodes;
C cathode electrodes with C cathode current collectors having a first side, a second side, a first end, and a second end,
wherein the first side and the second side are longer than the first end and the second end, and wherein C external tabs extend from the second side of the C cathode electrodes, where A and C are integers greater than zero; and
a separator comprising a continuous sheet interleaved between the anode electrodes and the C cathode electrodes,
wherein the A external tabs of the A anode electrodes are folded along the separator on the first side of the A anode electrodes;
wherein the C external tabs of the C cathode electrodes are folded along the separator on the second side the C cathode electrodes;
a housing including a first side, a second side, a first end, a second end, and an internal cavity, wherein the electrode stack is arranged in the internal cavity with the A external tabs and the C external tabs adjacent to the first side and the second side, respectively; and
first and second tab positioning members including first and second external lead tabs connected to the A external tabs and the C external tabs, respectively wherein the first tab positioning member includes:
a planar conducting portion extending along the first side of the housing and in contact with the A external tabs; and
an external lead tab connected to the planar conducting portion adjacent to the first side of the housing.

15. The battery cell of claim 14, wherein each of the first end and the second end of the housing includes first and second slots configured to engage opposite ends of the first tab positioning member and the second tab positioning member.

16. The battery cell of claim 14, wherein the first tab positioning member further includes:
a planar insulating portion arranged adjacent to the planar conducting portion; and
a second insulating portion extending transverse from the planar insulating portion,
wherein the external lead tab extends through the second insulating portion.

17. The battery cell of claim 14, wherein the second tab positioning member includes:
a planar conducting portion extending along the second side of the housing and in contact with the C external tabs; and
an external lead tab connected to the planar conducting portion.

18. The battery cell of claim 17, wherein the second tab positioning member further includes:
a planar insulating portion arranged adjacent to the planar conducting portion; and
a second insulating portion extending transverse from the planar insulating portion,
wherein the external lead tab extends through the second insulating portion.
